(19) United States
(12) Patent Application Publication
(10) Pub. No.: US 2008/0242177 A1
(43) Pub. Date: Oct. 2, 2008

(54) Decorative fabric and method for making a decorative fabric

(75) Inventor: Sheng-Nan Liu, Pa-Deh City (TW)

Correspondence Address: BACON & THOMAS, PLLC, 625 SLATERS LANE, FOURTH FLOOR, ALEXANDRIA, VA, 22314-1176, US

(73) Assignee: RUEY TAY FIBRE INDUSTRY CO., LTD., Tao Yuen Hsien (TW)

(21) Appl. No.: 11/730,234

(22) Filed: Mar. 30, 2007

(51) Int. Cl. C11D 3/00; B32B 27/02

(52) U.S. Cl. 442/164; 8/115.51; 442/168

(57) ABSTRACT

A decorative fabric has at least one layer and forms two surfaces. The at least one layer is woven with at least two materials. The at least one layer is corroded by at least one chemical agent to make a smooth emboss pattern. The decorative fabric provides an aesthetic appearance and is soft and smooth.

### BACKGROUND OF THE INVENTION

1. Field of the Invention

The present invention relates to a fabric and a method for making a fabric, especially to a decorative fabric with embossed decoration and a method for making the decorative fabric with embossed decoration.

2. Description of the Prior Art

A conventional decorative fabric falls into one of the following categories: (a) Jacquard fabric: a fabric with patterns knit on the surface of the fabric by Jacquard machinery; (b) glued fabric: a fabric with pattern materials glued onto the surface of the fabric; (c) embroidery: a fabric having a fastening base textile and embroidered patterns on the surface of the fastening textile; (d) pattern-woven fabric: a fabric made with an assembly of weaving methods and having patterns expressed by the appearance of the portions of different weaving methods; and (e) hot-press fabric: a fabric with hot-pressed patterns.

The conventional fabrics of these categories suffer from following shortcomings.

(a) The yarns or threads on the surface of a Jacquard fabric are easily frayed out.

(b) The pattern material of a glued fabric lacks softness. The glue used to attach the pattern material to the fabric continuously contact the user's skin and is hazardous to human health.

(c) The inner surface of an embroidery is rough.

(d) Applicable patterns of a pattern-woven fabric are strictly limited by weaving methods.

(e) Only shapes but no colors can be expressed by the hot-pressed patterns.

To overcome the shortcomings, the present invention provides a decorative fabric and a method for making the decorative fabric to mitigate or obviate the aforementioned problems.

### SUMMARY OF THE INVENTION

The main objective of the invention is to provide a decorative fabric with embossed decoration and a method for making the decorative fabric with embossed decoration.

The decorative fabric in accordance with the present invention has at least one layer and forms two surfaces. The at least one layer is woven with at least two materials. The at least one layer is corroded by at least one chemical agent to make a smooth emboss pattern. The softness and smoothness of the decorative fabric not only overcomes shortcomings of prior arts but also provide an aesthetic appearance. Because use of hazardous glue is eliminated, continuous skin-contact of the decorative fabric will not malignantly effect human health.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a decorative fabric in accordance with the present invention before treating with at least one chemical agent;

FIG. 2 is a cross sectional side view of the decorative fabric in FIG. 1 that has been treated with at least one chemical agent;

FIG. 3 is a top view of a smooth emboss pattern on the decorative fabric in FIG. 2; and

FIG. 4 is a flowchart of a method for making the decorative fabric in FIGS. 1, 2 and 3.

### DETAILED DESCRIPTION OF THE PREFERRED EMBODIMENTS

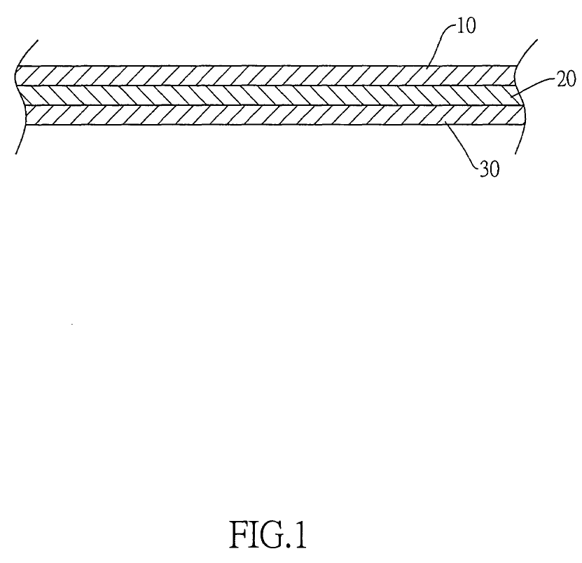

With reference to FIG. 1, a decorative fabric in accordance with the present invention comprises at least one layer (10, 20 and 30) and forms two surfaces. The decorative fabric comprises a first layer (10), a second layer (20) and a third layer (30). The second layer (20) is woven with a two-way Tricot technology. Each of the layers (10, 20 and 30) may be woven with Nylon, PET and PUE and has a top surface and a bottom surface. The materials with which the layers (10, 20 and 30) are woven may be evenly distributed or arranged to form a pattern. The bottom surface of the first layer (10) is sewed together with the top surface of the second layer (20). The top surface of the third layer (30) is sewed together with the bottom surface of the second layer (20). The top surface of the first layer (10) and the bottom surface of the third layer (30) respectively form the two surfaces of the decorative fabric.

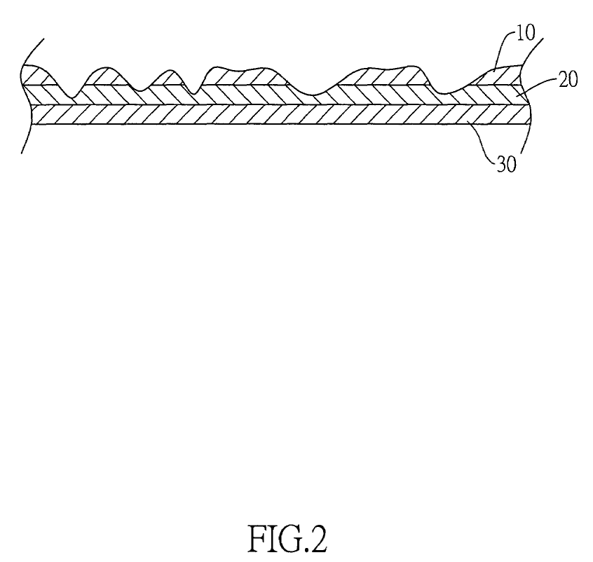

With reference to FIG. 2, a chemical agent is applied to the top surface of the first layer (10). The chemical agent corrodes into the first layer and may also corrode into the second layer (20). The corrosion of the chemical agent forms a smooth emboss pattern. Other chemical agents may be applied on the smooth emboss pattern to further adjust the emboss pattern. Some of the chemical agents may only corrode one of the materials, thus the corrosion can adjust the smooth emboss pattern according to the distribution of the material being corroded.

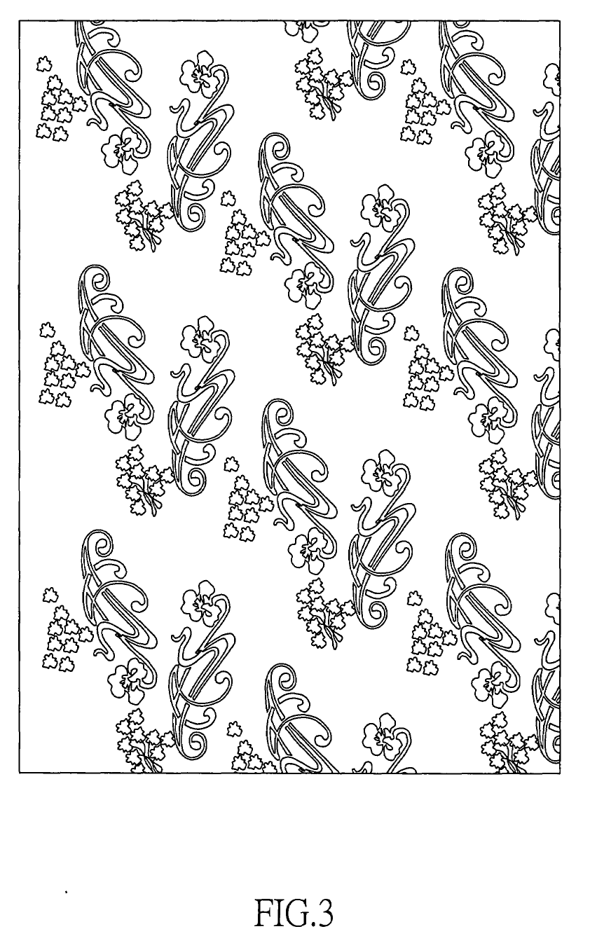

With reference to FIG. 3, the smooth emboss pattern is dyed with at least one dye. Since each dye may color only one, some or all of the materials with which the layers (10, 20 and 30) are woven, the smooth emboss pattern may be dyed according to the distribution of the materials.

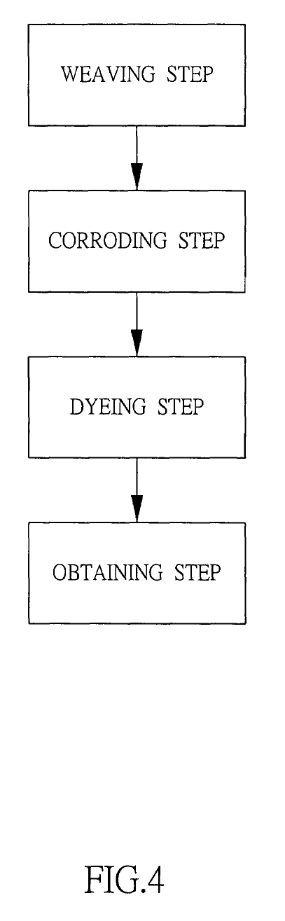

With further reference to FIG. 4, a method for making the decorative fabric in accordance with the present invention comprises a weaving step (a), a corroding step (b), a dyeing step (c) and an obtaining step.

The weaving step (a) comprises weaving at least one layer that each is woven with at least two materials. Each material is selected from a group consisting of Nylon, PET and PUE.

The corroding step (b) comprises corroding at least one of the at least one layer with at least one chemical agent.

The dyeing step (c) comprises dyeing at least one of the at least one layer with at least one dye to form a decorative fabric.

The obtaining step (d) comprises obtaining the decorative fabric.

With the interaction of the corrosion and the dyeing processes, the smooth emboss pattern exhibits aesthetic visual effect and avoids use of harmful glue being hazardous to human health to overcome the shortcomings of the prior arts.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A decorative fabric comprising
at least one layer that each being woven with at least two materials and
two surfaces that at least one of the surfaces is corroded by at least one chemical agent and colored by at least one dye.

2. The decorative fabric as claimed in claim 1, wherein each of the at least one layer is woven with Nylon, PET and PUE.

3. A method for making a decorative fabric comprising steps of
(a) weaving at least one layer that each is woven with at least two materials;
(b) corroding at least one of the at least one layer with at least one chemical agent;
(c) dyeing at least one of the at least one layer with at least one dye; and
(d) obtaining a decorative fabric.

4. The method as claimed in claim 3, wherein each of the at least two materials is selected from a group consisting of Nylon, PET and PUE.

5. The method as claimed in claim 3, wherein at least one of the at least one layer is woven with a two-way Tricot technology.
